(19) United States
(12) Patent Application Publication
(10) Pub. No.: US 2021/0056625 A1
(43) Pub. Date: Feb. 25, 2021

(54) ARTIFICIAL INTELLIGENCE AND MACHINE LEARNING IN A CLUSTERING PROCESSES TO DEVELOP A UTILITY MODEL FOR ASSET ALLOCATION AND AUTOMATED REBALANCING OF EXCHANGE TRADED FUNDS

(71) Applicant: Michael William Kotarinos, Palm Harbor, FL (US)

(72) Inventor: Michael William Kotarinos, Palm Harbor, FL (US)

(21) Appl. No.: 16/841,024

(22) Filed: Apr. 6, 2020

Related U.S. Application Data
(63) Continuation-in-part of application No. 16/548,595, filed on Aug. 22, 2019.

(51) Int. Cl. G06Q 40/04; G06N 20/00; G06F 16/2457

(52) U.S. Cl. CPC G06Q 40/04; G06F 16/24578; G06N 20/00

(57) ABSTRACT

Artificial intelligence and machine learning in a clustering process to develop a utility model for asset allocation, engineering and other applications. The present invention defines a group of assets using specialized electronic circuits. The invention provides a utility function preference criterion to a user using a graphics interface implementing a first preference criterion, a second preference criterion and a third preference to be selected by a user. The invention operates in clustering the assets using a multi-level time series clustering approach using machine learning function to establish parameters for a utility function based upon the selected desired preference criterion. The invention operates to pass the assets through the utility function to assign a utility score to each of the assets, rank the assets based upon the assigned utility score of each asset, and create a portfolio of assets.

### CROSS-REFERENCE TO RELATED APPLICATION

This application is a continuation-in-part of U.S. application Ser. No. 16/548,505, filed on Aug. 22, 2019 of which the entire contents of which is incorporated by reference in its entirety.

### FIELD OF THE INVENTION

The present invention relates generally to artificial intelligence and machine learning in a clustering process to develop a utility model for asset allocation and rebalancing of exchange traded funds.

### BACKGROUND OF THE INVENTION

Maintaining and managing a portfolio of investments has been analyzed and studied for years. There are numerous variables that contribute to the randomness of investing. Investing markets are often random in nature due to the illogical decision that often occurs. There is often an assumption in analytical models of rational participants in asset markets. In practice, the human nature of market participants sometimes leads to unpredictable markets, irrational decisions and market inconsistency. Prospect theory demonstrates some of these irrational trends. Tversky and Kahneman, Prospect Theory: An Analysis of Decision under Risk. 2013. Making, creating and managing successful portfolios of financial assets becomes a difficult task given these and other challenges. Studies have shown that the diversification of assets is the best and most effective way to maximize return on investment for a given level of risk. Additionally, it has been demonstrated that an investor cannot make accurate decisions in the market consistently; it is difficult to sell investments at a high price and purchase investments at a low price as market timing is often easy to do in retrospect, but difficult at the time. Price volatility of the investments in markets is impacted by news and other uncontrollable factors.

Modern portfolio theory is a current practice used to develop investment portfolios. The theory is based on a principal of attempting to maximize expected return for a given amount of risk or equivalent spreading the amount of risk through different types of investments to maximize the return. A highly utilized method to reduce risk is diversification or spreading the investment between different securities. If a few securities do not perform as expected, other securities should perform well, thus optimizing the total return on the portfolio.

Risk can be diversified by picking assets that are different with respect to a particular aspect about the assets themselves. The assets could be related to industry, country, type of asset, technology or more. For example, two stocks in the same industry may move together. Factors may cause the same two stocks within an industry to move differently. Additionally, two European stocks may move together while an American stock moves differently. There are a large number of ways that assets can be related and connected to one another that could result in a problem for the investor. Each investor is unique. Thus, the risks and concerns of one investor may be different from another, and a single measure of risk is often not a complete picture of the financial goals and desires of an individual.

A formulaic mechanism to diversify portfolios has been explored but poses problems due to the biases common in human behavior which influence investment decisions.

While U.S. Pat. No. 10,140,661 focuses on the time-relational aspects of information, it does not focus on developing tools for the client-adviser relationship and the creation of new portfolios customizable in real-time at the individual client level. Gerber fails to show an approach towards the inclusion of an artificial intelligence system. Similarly, U.S. Pat. No. 9,721,300 focuses on the use of random samples in the search process for optimal portfolio calibration. The prior art approaches are significantly different from the present inventions, instead focusing on suitability and a search process that uses an iterative time series search process occurring in real-time rather than a random sample-based search process. In particular, the process of Gerber uses statistical techniques such as Monte Carlo simulation, jackknife, or bootstrapping. While this type of package uses parallel computing-based approaches, such approaches are not inherently free of human or other bias. These methods are dependent on the assumptions underlying the simulation procedure and poorly specified assumptions can lead to misleading and inaccurate results. For example, Nassim Taleb argued that the reliance on simulation creates numerous issues that can lead to widespread and systematic asset mispricing. Taleb, The Black Swan (2007).

U.S. Pat. No. 10,290,059 focuses on the use of sliders for equity trading and simulation. Basu and Jain focus on the implementation using a Computer Processing Unit (CPU) based implementation. A CPU based implementation has the disadvantage that the routines are repeated and emphasized, which is much different than utilizing artificial intelligence. Further, more CPU based implementations rely on using CPU architecture to simulate the activities of a GPU to make machine learning based matrix computations. Integrated CPU computations of activities meant for GPUs are slow and not designed for wide-scale industrial use.

U.S. Pat. No. 10,191,888 also does not address new artificial intelligence developments. Riggs does not address the mathematical properties but whether or not the resulting asset selections are appropriate for a given investor. Further, Riggs does not develop the appropriateness of financial recommendations and is not targeted towards financial planners.

Therefore, there is a need to develop a method to classify or cluster assets to create a diversified portfolio which can be modified in a timely manner based on client preferences. This would be very useful and essential to investment decision-making and the practice of diversification. The securities would be separated into groups via a clustering method that maximizes similarity within groups and minimizes similarity between groups. Using artificial intelligence and machine learning in a cluster process to develop a utility model for asset allocation would allow one to figure out what combination of assets could make up a well-diversified portfolio for each individual investor based on the needs and desire of that investor.

There is a need for a clustering method for maximizing the diversification of a client on a real-time manner based on the preferences of the client. There is also a need to rebalance a portfolio to optimize the portfolio during the life of the portfolio.

Markets are dynamic and often change. Thus, there is also a need to rebalance portfolios. In modern portfolio theory it can be difficult to determine when to rebalance a portfolio. As markets change and investment goals evolve, a portfolio manager needs to adapt the portfolio to contain the appropriate assets for the current market conditions. If a portfolio manager changes a portfolio too often, he or she will incur a significant amount of fees for the client for minimal gain in suitability. If an investment manager does not rebalance often enough, then the client will have a portfolio of assets that are inappropriate for current market conditions. The present invention develops a method to make automated portfolio rebalancing suggestions by evaluating a utility function and listing the suggested order in which changes should be made to a portfolio.

There is prior art which demonstrate the difficulties in rebalancing portfolios. Prospect theory has shown an empirical trend for individuals to make mistakes when rebalancing portfolios by holding on to positions that are at a capital loss for too long. Calvet, Campbell and Sodini, 2009. As such, automated tools that tie rebalancing to individual utility and suggest an order to make transactions has significant applications. This development is not trivial as it requires estimation of an individual utility function and the tying of this utility function to a decision-making framework for rebalancing that considers real-time market conditions.

U.S. Pat. No. 10,262,368 involves an automated trading method. The '368 patent focuses on multi-agent trading based on trading patterns, and is not focused on client suitability and the development of a utility function.

U.S. Pat. No. 8,768,810 likewise does consider utility and rebalancing but focuses on preferences over risk. This dynamic framework focuses on stochastic methods but is not a multi-dimensional utility function that incorporates investor suitability. Further, the '810 patent does not focus on using big data methods to dynamically detect pools of possible investors for the development of new ETF products. The focus on risk and return is different from the risk, return, and suitability framework that forms the foundation of this method and the consideration of complex financial goals. In particular, the '810 patent uses a discounted wealth model while the proposed patent here uses a paradigm of financial planning and meeting financial goals. As such, the goals and objectives of these two methods are different and represent different approaches to automated rebalancing procedures. The current invention focuses on creating an optimal portfolio and comparing the optimal portfolio and the current portfolio.

U.S. Pat. No. 8,725,614 focuses on creating investment streams for sustainable income streams. This is an example of one particular investment goal. However, many investors often have more complex goals or desires rather than fixed payout periods. The platform and techniques developed here do not focus on a specific payout period of rate, but rather on broad investment goals for a client and the appropriate rebalancing time.

U.S. Pat. No. 8,335,735 focuses on creating automated rebalancing for risk management using future contracts. The '735 patent focuses on a different goal of short-term risk management with daily rebalancing Alternatively, the present invention focuses on long-term goals and financial planning objectives. A distinction can be seen in the type of assets that are used. Mixing numerous liquid futures contracts into a financial instrument would not be appropriate for many investors and would violate many suitability conditions. Since many investors would have a hard time assessing a portfolio of numerous futures contracts, they would not be able to assess the risks of their investments, and as such this may not be considered an appropriate investment vehicle for many investors. While the aforementioned patent does discuss tying rebalancing to a financial product the composition, investment timeline, goals, and structure of this product is different from the structure of the products proposed in this patent application.

The present invention is a significant departure from the prior art and is a new way of thinking about an exchange traded fund (ETF) product. Most ETFs are designed to track indexes or offer a specialized investment exposure, not meet broad suitability requirements for large groups of investors. The prior art lacks an automated tool to aid in rebalancing. As such, there is a need to create a new call of ETF style products.

Further, the present invention run the differences through a GPU utilizing a scoring system considering user stability, size and market conditions.

### SUMMARY OF THE INVENTION

The present inventions are generally related to a system and method for using artificial intelligence and machine learning in a clustering process to develop a utility model for asset allocation. The present invention utilizes a signal which is an individual event, element or feature. An asset, security or individual stock may be a signal. Clustering categorizes signals into a unit or group having similar features. Clusters are based upon signals. For example, a cluster could be formulated based upon the structure of a particular stock. The S&P 500 could be specified as a cluster. Likewise, technology stocks within the S&P 500 could be specified as a systematic cluster. The type of cluster is unlimited and can be expanded beyond financial markets to areas such as engineering or the like.

One of the major areas of application for machine learning and other methods is in the area of clustering. In this process, a group of objects are broken down into blocks or clusters that have similar characteristics and features. Different clustering methods have different levels of applicability depending on the nature and structure of the market data being considered. Real-time data structured over time is often called time series or panel data. This time dependency creates a spatio-temporal relationship in the data set. Because of the time dependency, data needs to be evaluated in terms of its values at a particular time as well as its position in time to make decisions.

Because of the time dependency, different clustering methods are used for clustering these signals. For example, one type of a clustering approach is called Mutli-Level Time Series (“MLTS”). An MLTS clustering approach analyzes different non-stationary signals over time. The approach puts signals into a cluster based on a function over time. The process of MLTS clustering deconstructs a signal over a period of time and undertakes the task of determining the most relevant lag distances to identify and define meaningful relationships between the signals during a given period of time. The lag distances are used to characterize the relationship between the assets and assess which asset signals over the period of time most closely exhibit the desired relationship. The most desired relationship may be what is known as or referred to as a cointegrated stationary relationship, where the difference between two time series of some lag order would be considered a stationary process. The difference between two time series would be considered a stationary process. That is, the series generated by some lagged difference of Y and Z could be stationary even though Y and Z are not individually stationary. The cointegration is where two time series x and t and can be described by a stationary process. As an example, it could be determined that the most appropriate lag distance that characterizes assets A, B, C, and D is a lag order of 1 between A and B, 2 between C and D and 3 between A and D. In this example, A and B would be clustered together and C and D would be clustered together.

Other examples of clustering approaches include K-Means clustering, support vector machine learning and neutral network clustering. K-Means clustering is a method of vector quantization that is popular for cluster analysis in data mining. K-Means clustering aims to partition a number of signals into various clusters in which each signal belongs to the cluster with the nearest means. The problem with K-Means clustering is that heuristic algorithms converge quickly to a local optimum. K-Means clustering has been used in market segmentation, computer vision and astronomy. The problem with these clustering methods is that they make assumptions of normality that cannot be justified. They cannot adjust to the need to consider the function of a cluster over time.

Once signals are clustered, they can be used and analyzed in various applications. Clustering is sometimes used to filter out different non-stationary signals to detect trends. Clustering theory is not often utilized due to the difficulty in making decisions based on clusters and the complexities involved in the clustering process. Thus, simpler methods are used which are easier to understand even though they do not correctly address the time dependencies in real data. The result is that the analysis being used by financial planners and analysts tends to be easy to understand, but inherently misleading. The present invention aims to address this deficiency through innovative linkages and new analytical developments.

The present inventions include a novel approach to make disparate clusters useful by linking real-time based clustering procedures to a utility function for a particular user or group of users. This utility function serves as a delivery mechanism for the construction of asset portfolios that can be tailored to individual users. This process extends the traditional structure of risk and return to a new framework that uses risk, return, and suitability for the determination of risk. The approach of the present inventions combines multiple different fields, disciplines, and insights including schematics from computer science, machine learning, statistics, finance, accounting, financial planning, and financial compliance. The necessity of insight from so many diverse fields makes the development and use of this application significantly different and more insightful from much of the other work done in the clustering area. The present invention is unique in its construction and application using state-of-the-art methods incorporating machine learning and artificial intelligence, which allows for more insight and analysis into underlying market fundamentals that can help financial planners deliver sophisticated tools to their clients in a real-time and understandable way, bridging the gap between complex methods and end users.

The present inventions are scalable to big data environments and to cloud computing infrastructures and allow for insights at the individual user level. The present invention includes the benefit of defining a group of assets using a specialized electronic circuit configured to rapidly manipulate and alter memory such as a graphics processing unit (GPU). In terms of GPU: GPUs are Graphical Processing Units that are known for their ability to perform complex matrix computations. The mathematical form of many of the computations performed are in something known as a matrix. This consists of rows and columns of information in something that resembles a table, but with some additional detail. Likewise, the present invention offers the benefit of utilizing a utility function preference criterion to a user using a graphics interface for implementing a first preference criteria, a second preference criteria and a third preference; selecting from a range of preferences to a desired preference from the first preference from the first preference criteria, the second preference criteria and a desired preference for the third preference criteria; sending the selected the desired preferences from the first preference criteria, the second preference criteria and the third preference criteria to the GPU; scoring the parameters for a sector based on the desired preference from the first preference criteria, the second preference criteria and the third preference criteria to the GPU; clustering the assets using a multi-level time series clustering approach to form sectors; compiling utility functions parameters using a machine learning function information to estimate a utility function based upon the selected desired preferences from the first preference, the second preference criteria and the third preference criteria to the GPU; formatting a utility function within the GPU; passing the sector of assets through the utility function to assign a utility score to each of the assets; ranking the assets based upon the assigned utility score of each asset; comparing the ranked assets to a utility score established for an individual; and creating a portfolio of assets which match the utility score of the ranked assets.

Likewise, other advantages of the present inventions include: filtering the assets to iteratively adding or dropping assets from the portfolio to optimize the global risk and return; a first filtering of the assets to iteratively add or dropping assets from the portfolio iteratively selecting only the highest predetermining scoring assets; a second filtering of the assets to select a range of assets having the highest and lowest predetermined scores; a utility function preference criteria to a user which comprises a slider application as part of the graphic interface; the offering of a utility function preference criteria to a user which incorporates the combination of a slider, a box and a range; and extending time series-based machine learning data to a supervised machine learning environment.

Additional advantages of the present invention include: extending time series-based machine learning data to a machine learning environment to create clusters of assets; selecting individual assets from the clusters of assets; displaying on a graphic interface a plurality of sliders to represent preselected individual preferences for the blocks of assets; selecting individual preferences using the slider; compiling the selected individual preferences; selecting a cluster of assets to evaluate; creating an individualized utility function linked to the selected individual preferences; utilizing the individualized utility function on the cluster of assets by passing the selected cluster of assets through the individualized utility function; and sorting the assets based upon the results of the individualized utility function.

One of the fundamental issues in finance pertains to rebalancing a portfolio. Once a final portfolio is constructed, that particular portfolio provides the optimal compilation of assets at the particular period of the analysis is conducted. However, markets are dynamic and constantly changing. After investing a portfolio in several assets these assets will change over time. Company may change its fundamentals making the company a riskier investment than the time period the initial portfolio was constructed. Additionally, market prices may change making assets significantly cheaper or more expensive, and client goals and objectives may change. Because of this, financial planners must change the asset allocation for their clients through a process called rebalancing.

An advantage of the present invention addresses the difficulties associated with rebalancing of portfolios. Rebalancing smaller client portfolios can have significant fees relative to assets and can also take a great deal of adviser time. For larger clients, there may be liquidity issues that makes it very difficult to change asset positions.

The rebalancing of the present invention operates to reconstruct a portfolio developed in real-time and is scalable to cloud computing environments. For example, a firm with many clients may notice that it may have several clients with similar profiles. For example, clients in their 30s who are looking to save for a home may select criteria which tend to support relatively low risk companies with strong growth. If there are many clients with a similar profile, they may wish to invest in similar companies. Because of this, a firm may find that certain criteria end up in very similar ranges. If many clients end up with very similar criteria selections, then it may be more feasible to purchase an exchange traded fund for these clients. Thus, rather than managing several individual client portfolios, the clients having similar criteria can be managed using an exchange traded fund. This would give the clients a simple, straightforward portfolio with added liquidity rather than many individual assets. Further, these ETF products could have aspects of a mutual fund—management based on a set of goals and principles, rather than merely tracking an index—but could still be automated and feature many of the features that make the index tracking ETFs so appealing, such as low fees and high degrees of liquidity.

Using the automated rebalancing technology combined with trends and data patterns could be used with the development technologies of the present invention, to create automated exchange traded fund products that meet the needs for a group of clients which track a set of utilities, not a particular index.

One of the benefits of the present invention is to operate to identify groups of clients that have a tendency to have similar criteria to apply a portfolio. The system operates to first determine an optimal portfolio. Second, the system operates to compare the optimal portfolio to a current client portfolio. Third, the system function will score the differences between the current portfolio and the optimal portfolio based upon a different measurements metric. Fourth, the score is checked to determine if a rebalancing of the portfolio is required.

Another advantage of the present invention functions to analyze the difference between an optimal portfolio and a current client portfolio. The differences are measured using a scoring metric. Next, the system operates to pass the scoring metrics through a scoring system that considers conditions such as user suitability, size and market conditions for each of the differences. The system further operates to order a rebalancing list from a highest rank to a lowest rank based upon conditions associated with the current market conditions and the associated utility function related to each of the market conditions. The system next operates to generate a flag notification to alert a user of the rebalancing.

Another object of the present invention is to create an Exchange Traded Fund (ETF) type of product to meet the needs of a specified group of clients. The computer system includes a database of clients and client criteria and utilities. The program operates to the client criterial and utilities and client information in the database to analyze the criteria and information to find blocks of client information with common criteria across utilities. The system functions to determine possible ETF products. If a possible ETF product is detected, the system will define a utility function to create a set of rules to govern the ETF using an automated rebalancing algorithm. The rebalancing algorithm: (1) determines goals, (2) determines rules and appropriateness of the rules, and (3) determines rebalancing criteria creating an Exchange Traded Product. The Exchange Traded Product is listed on an exchange.

A further object of the invention is to create an ETF product that operates to:
1. Identify a group of individuals with similar investment goals and characteristics using big data analytics.
2. Structure an ETF style product that meets a utility function derived from this group based on the optimal portfolio built from the utility functions based on the criteria of the user.
3. Formalize the rules for this ETF product for a given set of customers by (a) determining the appropriate utility function, (b) determining the automated rebalancing rules, (c) using the automated rebalancing rules to structure the fund over time, balancing exchange fees with user suitability, using the given automated rebalancing algorithms, and (d) charging a management fee on a scheduled basis.
4. Offer this ETF product through a filing made with the Securities in Exchange Commission, or through a similar process in other countries besides the United States of America.
5. Charge a fee to customers for this ETF product.
6. Allow users to purchase the ETF product.
7. Synchronize the ETF product with other offers in a smart and intelligent system for securities recommendations for clients.

Other systems, methods, and features of the present invention will become apparent to one of ordinary skill in the art upon examination of the following figures and detailed description of the preferred embodiments. Certain embodiments will be better understood when read considering the figures and detailed description of the preferred embodiments. It should be understood that the embodiments are not in any way limited to the arrangements or instructions shown in the attached figures.

### DESCRIPTION OF THE FIGURES

Other objects and advantages of the invention will become apparent upon reading the following detailed description and upon reference to the following drawings:

FIG. 1 depicts an example of a clustering process;

FIG. 2 depicts an example of the use of MLTS clustering;

FIG. 3 depicts a process flow diagram directed to an estimated utility function used to select assets;

FIG. 4 depicts a traditional risk-return framework;

FIG. 5 depicts the risk return suitability framework resulting from the estimated utility function of the present invention;

FIG. 6 depicts the risk return suitability framework resulting from the estimated utility function of the present invention;

FIG. 7 depicts a local search process and presented portfolio flow diagram.

FIG. 8 illustrates the flow diagram of the function for each step of the method for automated rebalancing of an exchange traded fund;

FIG. 9 illustrates a flow diagram of the steps of the method for automated rebalancing of a portfolio;

FIG. 10 illustrates a flow diagram of the steps of the method for automated rebalancing of a portfolio; and

FIG. 11 depicts the steps for the method to create an Exchange Traded Fund product to integrate the criteria of a select group of users.

### DETAILED DESCRIPTION OF THE PREFERRED EMBODIMENTS

The embodiments of the present inventions provide a system and method for using artificial intelligence and machine learning in a cluster process to develop a utility model for asset allocation. The utility function takes items and rates the items based upon a preferred criteria. The utility function is unique to each individual investor. The utility function provides a score for each signal within a cluster based upon an individual's unique preference. Each item is processed using a utility function to match items to a preference. For example, the utility function may be used to match an investor's portfolio to the most appropriate assets given his or her preferences.

Each cluster may have a sub-cluster. The invention of the current application operates to perform a plurality of utility functions on each cluster. Thus, the invention extends the utilities to multi-dimensional representations, with applications beyond finance. The utility function weighs the criteria of the sub-cluster and determines a new cluster. The utility function of the present invention does not necessarily use a filter.

The present invention operates for a multitude of assets beyond equities including bonds, futures, swaps, and commodities. Further, it is not a simulation-based approach but uses real-time market data to reach a conclusion. The package of tools is able to bypass the use of simulated portfolios and represent real-time portfolios via the use of cloud computing, artificial intelligence, and machine learning tools. This approach is scalable using cloud computing to grow dynamically and operate on a global level on an as-needed basis to adjust in real-time to changing market conditions and demand for the platform.

The use of machine learning and artificial intelligence makes heavy use of GPU based implementations. One of the hallmarks of machine learning is the GPU infrastructure used to efficiently operate and command the machine learning foundations used as a delivery mechanism in this package of tools. A CPU cannot operate to simulate the actions of a GPU and operate to command the machine learning foundations used for the clustering of the present invention. It is not feasible to use CPU architecture in a wide-scale system infrastructure due to the different hardware structure between GPUs and CPUs. CPUs attempting to perform GPU calculations will need to use integrated CPU graphics techniques, which are slower and not designed for widespread industrial use.

The search process of the present inventions utilizes methods such as Markov Chain Monte Carlo (MCMC), which is a high-dimensional alternative to standard Monte Carlo practices. There has been a significant increase in graphical processing unit type processing availability that allows for widespread and real-time application of the MCMC development that was not possible at the time of the aforementioned patent.

The connection of a real-time based clustering process to a user driven utility function that considers the suitability of assets for an individual should not be tied to a specific clustering algorithm. For illustration purposes one may consider Multi-Level Time Series (MLTS) Clustering, which is an analytical process developed to allow for clustering of financial assets over time. This process investigates lag dependencies to make conclusions about suitable asset clusters. MLTS Clustering involves a seven-step process:
1. Break assets into different blocks based on a criteria related to the asset class, such as market sector.
2. Look at each block. Calculate pairwise distances for each lag up to a chosen number.
3. Construct dissimilarity matrices based on these lags.
4. Perform clustering using the constructed dissimilarity matrices.
5. Select a trading interval (target lag k).
6. Analyze neighborhood lag solutions.
7. Create sub-clusters for each group.

Consider a large group of stocks. The group could be divided based on market sector, and further subdivided from market sector into market sub-sector using MLTS clustering. A candidate group could consist of 500 companies numbered 1 to 500 as possible candidates for a portfolio. Clustering this into sectors could lead to a block of companies identified as being technology companies, say companies numbered 1 to 40. This block could then be sub-clustered, so the technology block would be further divided into sub-clusters 1, 2, 3, and 4. For example, sub-cluster 1 could consist of the companies numbered 1, 6, 8, 14, 32, and 40.

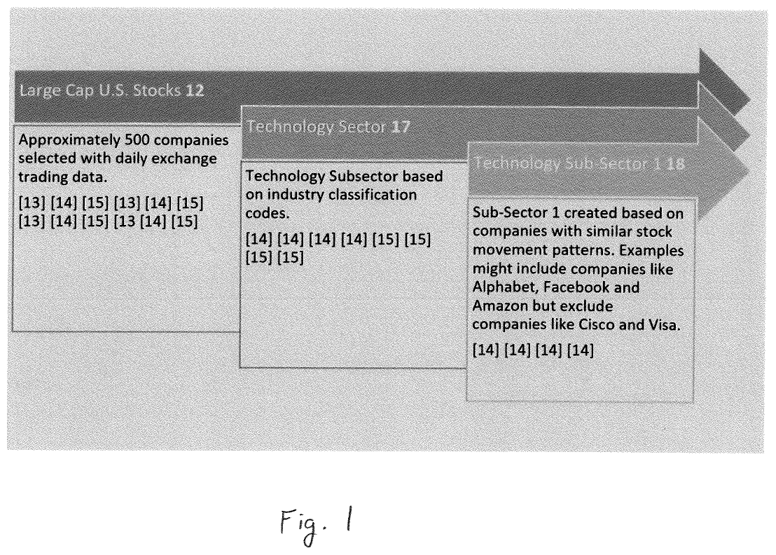

An example of the clustering routine can be seen in FIG. 1. FIG. 1 depicts three different clusters. Clustering typically uses two parameters. A grouping of 10 comprises of a first cluster 12 of large cap stocks. The first cluster 12 is made up of individual stocks in groups 13, 14, 15, 16 comprising approximately up to 500 companies which were selected based upon daily exchange trading data. Thus, the individual stocks 14 in the first cluster 12 are selected from the cluster by utilizing a filter. The selection is a time series based on clustering. The time series based on clustering may be used to select stocks based on the preferred daily exchange trading data. The information in the first cluster 12 is processed using a utility function to generate a second cluster 17 of individual stocks based on industry classification codes in the preferred embodiment the second cluster 17 is indicated by a technology sector. The industry classification codes are data that describe what sector the companies may be classified. For example, Alphabet and Google may be considered to be in the Communications sector, Microsoft in Technology and Exxon in Energy. This step may be provided by a third-party data provider via an Application Programming Interface (API). Basically, a third-party tool that synchronizes with our tool, which is in itself an API. A third-party data provider sends data, which the clustering turn into insights, which can be passed along to another user in another API. Each API has usage limits and rules, subject to the usage agreement. Thus, only individual stocks 14, 15 that have selected industry codes comprise stocks 14, 15 in the second cluster group 17. Next, a further utility function is run on the individual stocks 14, 15 of the second cluster group 17 to select a sub-sector of the group.

For example, the sub-sector group 18 could be generated based on companies with similar stock movement patterns to create a group of sub-sector stocks 14. In an example, the first cluster 12 may be made up of all large cap U.S. stocks in groups 13, 14 and 15. The second cluster 17 would be a selected technology sector made up of technology stocks consisting of groups 14, 15. The sub-sector cluster 18 would be individual stocks from technology sector 17 that include companies with similar upward stock movement patterns, group 14, like Alphabet and Facebook, for example, but exclude stocks 15 with a downward pattern like Cisco and Visa. The different classes may be selected using filter techniques.

One of the difficulties is connecting the sub-clusters 18 of FIG. 1 to useful applications by asset managers. This problem is addressed through the creation of a customized utility function for each user. The clustering process serves as a delivery mechanism of sub-clusters 18 that exhibit different time-based movement patterns. Each one of these sub-clusters 18 tends to move and react differently over time from the other sub-clusters. Thus, by taking individual group of assets 13, 14 and 15 from each sub-cluster 18 the end user will gain an additional level of diversification. Rather than just having diversification of risk at a single point in time, the end user receives a portfolio of assets that have different behavior of risk on a structural level, as the different signals have varying lag order dependencies. The signals having varying lag order dependencies extends the traditional discussion of risk from simply risk and return to dynamic risk and return over time and allows the method to adjust in real-time to changes in market conditions.

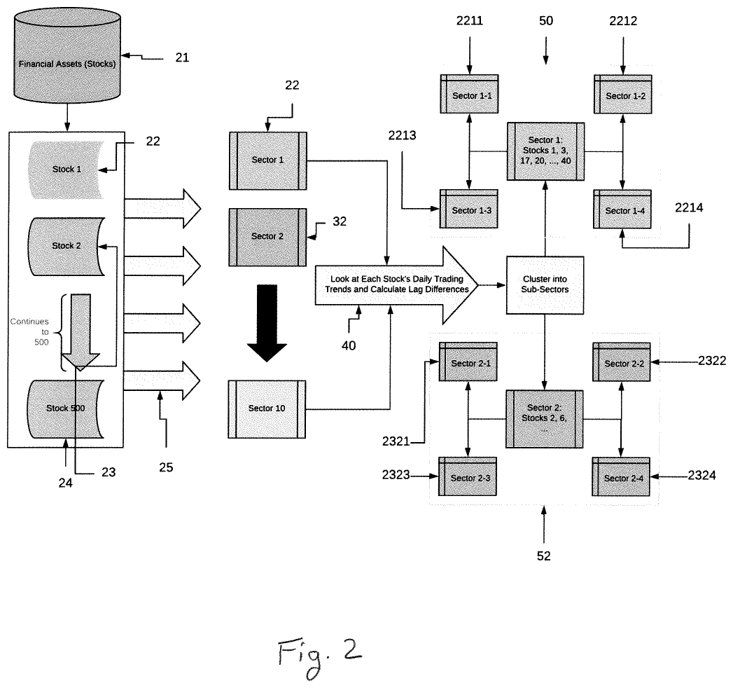

FIG. 2 depicts a flow diagram showing how the MLTS clustering is executed. The MLTS clustering process 20 of FIG. 2 starts with a group of signals 21, which in this example includes a group of financial assets or stocks. The group of signals 21 are made up of individual signals or assets 22, 23, 24, etc. In the example of FIG. 2, there are up to 500 different signals or assets. Each of the assets 22, 23 . . . 24 in a sub-cluster is passed through an individual utility function 25. A utility function is a function that represents a rank order of preferences. Each individual has different preferences, and as such has a different utility function. The preferences of an individual are reflected by criteria of that user. This function takes different bundles of goods or choices and represents them by a number or score. Higher scores are more preferred than lower scores and as such choices with higher scores are chosen over lower scoring choices.

Through this process, each asset 22, 23 . . . 24 is scored using a metric to determine the suitability of the asset for the individual investor. In FIG. 2, the assets are segmented into clusters 30 called sectors 31, 32 . . . 33. For example, sector 31 represents the assets 22, 23 . . . 24 which correlate with the preference of a particular individual utility function 25. The assets 22, 23 . . . 24 are ranked by score within the utility function 25 to correlate the assets 22, 23 . . . 24 into various clusters 30 based upon the score assigned to the assets 22, 23 . . . 24. The cluster, sector 1 in FIG. 2, 22 is the asset's 22 ranking in the top placement of the utility function 25 criteria. Likewise, the cluster 23, designated as “sector 2,” is assigned assets 23 which do not correlate to the criteria as much as the first sector based upon the selected criteria of the utility function 25. Sector 10 in FIG. 2 represents a cluster 33 of the assets 24 which have the least degree of correlation with the selected parameters. A utility function simply provides a ranking between assets. It does not tell how much more one asset compares to another. In other words, the difference in how much value is applied between a utility score of 100 and 101 may actually be bigger than the difference in scores 1000 and 10000. The highest scoring assets 22, 23 . . . 24 in each cluster are passed on as candidates for a possible portfolio, subject to the restrictions placed by a financial professional. The assets of a selected cluster 31, 32 . . . 33 may be processed by a second utility process 40 to determine a second level of criteria.

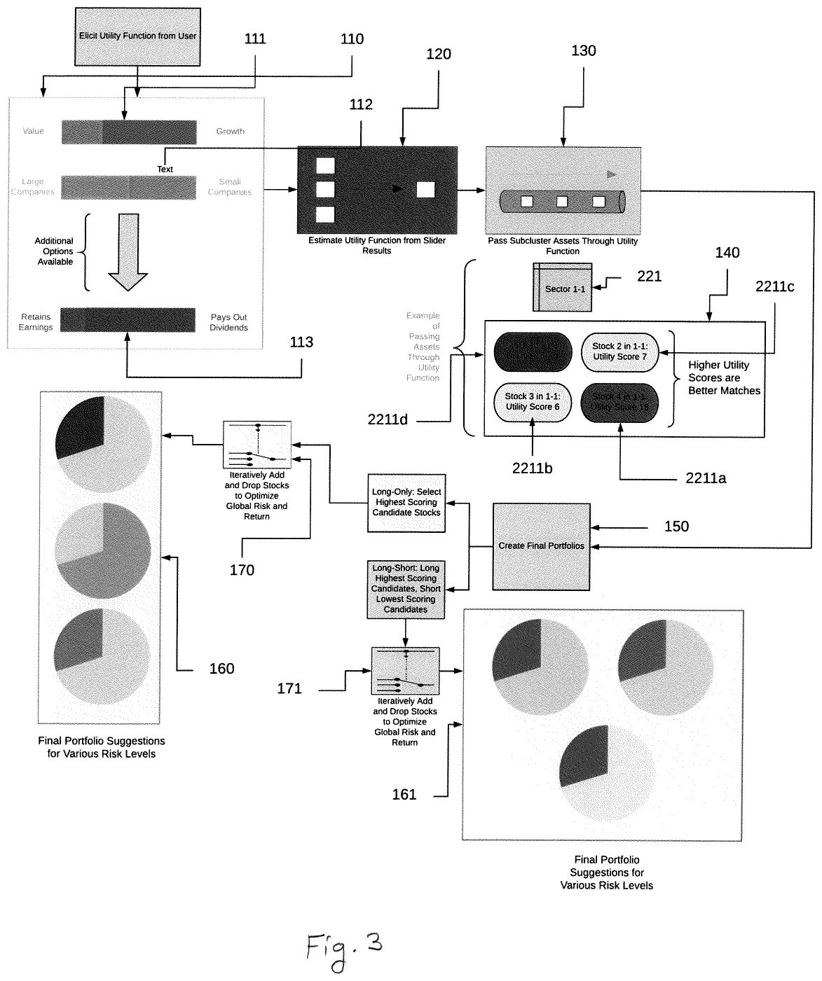

The assets are clustered based on activity over time as shown in FIG. 3. The two utility functions in this example are “Risk vs. Return preferences” and “Preferences over unique characteristics of assets.” For example, investor A wants a low risk portfolio that is light on real estate. Low risk is Risk vs Return. The first step would be to cluster the assets that are quantified as “low rise” assets. The assets would be clustered by the utility function 25 to determine which assets are in Sector 131 which represents “low-risk assets.” The second utility function would be to create a portfolio that is light on real estate. These are just a few examples of the type of utility function that may be used in the present invention. The important part of the invention is to use two utility functions.

In the example of FIG. 2, the second utility process 40 determines each stock the sectors 30 to analyze the daily trading trends and calculate the lag differentials. The assets 22, 23 . . . 24 are clustered into sub-sections 50, 52 based on each of the clusters 31 and 32. The assets 22 of sub-sectors 50 are coordinated into sub-clusters in the sub-sectors 2211, 2212, 2213 and 2214. Likewise, the assets 23 of sub-sector 52 based on cluster 32 are coordinated into sub-sector 2321, 2322 and 2323.

In the example of FIG. 2, by default the highest scoring assets 22 are passed on as candidates through utility function 40, but the asset manager may restrict the final selection so that a certain sector 2211 in FIG. 3 must have a certain number of companies represented in the final mix.

The analytical clustering process serves as a delivery mechanism of assets to a utility function that processes the assets for scoring. In order to do this, a preference revealing mechanism is needed. This is a device or process that allows one to analyze and estimate a utility function for a user or group of users. This innovative new approach of viewing clustering takes the clusters of assets not as the end result of a long period of analysis, but rather as a gateway to being able to contextualize and use utility functions in real-time. This process elevates the utility function usage from being an esoteric tool of economists to be a useful, meaningful application that can be accessed and used by individuals without advanced training in economics. This process may also be facilitated with the aid of a financial planner. The financial planner does not need advanced training to use or apply this process but simply the skills that are bare minimum necessities to meet the requirements set by Financial Industry Regulatory Authority (FINRA) and the Securities and Exchange Commission (SEC). Those giving financial advice in the United States are bound by the rules and regulations set out by the SEC and managed in coordination with FINRA. However, the underlying principles of financial planning such as a fiduciary responsibility tend to be common across many countries.

One possible elicitation method is the use of sliders, although this is not the only possible approach. In a slider, two different options are presented. The user adjusts the slider to the left or the right depending on how much he or she favors one criteria over another criteria. For example, for a slider of Growth versus Value the user can slide the slider to the left to pick assets that are expected to grow over time and can slide the slider to the right to select assets that are very valuable right now but have weaker growth prospects. Assets in the middle of the slider have some aspects of growth and some aspects of value.

The present invention utilizes a feature to elicit unitary function criteria information from a user or client. The information provided by the user forms the basis for scoring in the utility function. Some examples of the criteria used in the user response feature include value vs. growth, large company vs. small company, retained earnings vs. dividend, to name a few. The user response feature allows the user to adjust the available options to customize the utility function for that particular customer.

The present inventions use sliders as part of the user response feature which solves a difficult and nuanced problem. A user's true utility function is unknown, so one must be estimated. However, estimating a utility function is an extremely difficult process. Individuals tend to misrepresent the nature of their beliefs, and in some cases, do not even know what their actual preferences truly are due to the presence of biases and other issues. The present invention uses a reliable and easy-to-use method to investigate user preferences. The method is also suitably deep and comprehensive enough to measure complex beliefs. The sliders designed are simple enough for users to interact with, but also have sophisticated features for advanced detection. The user response feature includes customized helper functions to help users make decisions on each slider through an interactive question-and-answer program. The user response feature includes a global function evaluating how all the sliders move jointly with one another, and automated tools that check for inconsistencies and possible issues with the stated preferences. The user response feature combines ease-of-use of the end user with sophistication and depth for the financial planner.

In addition to sliders, check boxes and ranges can be used in the user response feature. Check boxes enforce very specific conditions that limit the search, for example not allowing foreign American Depository Receipt (ADR) stocks (foreign stocks that trade on domestic exchanges). Range boxes limit assets to certain ranges, for example limiting the search to companies with a market cap under $10 billion. The combination of sliders, range boxes and check boxes allow for an interface that can lead to an estimation of an end utility function.

The sliders, boxes, and ranges may be combined in the user response feature with tutorials that explain how each of these devices work and help the user make trade-offs by explaining what different assets in each group are like, with example companies updated in real-time based on the clustering process. These final utility functions are unique to each individual user and represent an estimation process that attempts to represent the individual's unique needs and financial goals and objectives that are used in conjunction with a financial planner.

In the system of FIG. 3, there are at least 3 sliders 111, 112 and 113. Each slider 111, 112 and 113 depicts different criteria. The sliders 111, 112 and 113 allow a user to select specific criteria which then represent the user's preference for the criteria of one slider over another. For example, in the example of FIG. 3, the user has selected a higher preference for value over growth in slider 111, while selecting a neutral preference in the second slider 112 comparing large versus small companies, and selects a preference toward retained earnings in the third slider 113. The sliders represent a user's preference.

Each of the sliders 111, 112 and 113 provide information about a user and their preference over criteria. The criteria selected by a user can be analyzed using artificial intelligence to determine which common criteria a user prefers. The artificial intelligence is used to determine the common criteria that is preferred by the user. The analytical approach can determine what criteria is important to the user. The program, using artificial intelligence, can statistically detect a preference pattern and learn what is important to the user. For example, if a user moves a slider closer to growth, the utility function will score stocks with growth features higher. All else being equal a company with a higher growth in revenue on a year-to-year basis will score higher. This is a non-trivial process as sliders could be related to each other (interacted) and work with each other in non-linear (complicated) ways. Taking this complex, nuanced process of estimating a utility function and boiling it down for the user of moving a slider to the left or right allows individuals without advanced mathematical and statistical training to be able to use artificial intelligence to help them make decisions without being an expert in AI systems.

FIG. 3 sets forth the application of the clustering process technique utilizing artificial intelligence and machine learning to develop a utility model. In FIG. 3, the user response feature 110 is used to elicit information from a user based upon a series of sliders, boxes or ranges. The users are asked a series of questions about the users to provide information about the user. In FIG. 3, the first slider 111 requests the user to select between the extent of growth stock as compared to value stocks a user prefers. The slider 111 may be presented as an interactive graphic interface on a computer, cell phone or other device. The user can move the bar on the first slider 111 to select a preference between growth or value. There may also be a second slider 112 in the user response feature 110. The second slider 112 allows the user to adjust a preference towards large companies or small companies. Additionally, the user response feature 110 may include a third slider 113 for a user to input his or her preference for assets having retained earnings as compared to paying dividends. While FIG. 3 depicts three sliders 111, 112 and 113, there are additional options available to measure a user's preference for different criteria in the stock market such as check boxes and scales. There may also be a “?” help button if users are unsure about how a slider works or what it means with helpful tips. For example, in a slider of “Small cap vs. Large cap” the slider will explain what market capitalization is and give some example. For example, a Tech Large cap might be Apple, Mid cap mid be Tesla and small cap might be Docusign. This would be updated in real-time to make sure the examples are current with actual market conditions.

After the user selects the preference using the sliders 111, 112 and 113, a utility function 120 generates an estimate based on the slider results. The slider 111, 112 and 113 are given weighs in a scoring process for each criteria of the sliders. The artificial intelligence program sets an overall scoring criteria for the selected parameters. Broadly speaking as a user moves the slider 111, 112 or 113 closer to a given criteria the factors related to that criteria will be given bigger weights in the scoring process. The actual weights would vary and depend on market conditions. The process is similar to how a search engine is constantly being updated so too would the weighting and combination process continually be updated.

In FIG. 3, a utility function 120 is generated based on an estimate from the criteria entered by the user through the sliders 111. The utility function 120 sets the rules or parameters of how to score the various assets 122, 123 and 124. The utility function 120 is a broad, generic mathematical tool that can have several dimensions, in this case three dimensions each of which corresponds to one of the sliders 111, 112 or 113. The utility function 120 is determined for each individual user. Based on the criteria selected by the sliders 111, 112 and 113. The individual utility function is determined. Machine learning and artificial intelligence are the tools we use to estimate an individual's utility. In this case, instead of performing in a two-dimensional framework of risk and return, the present invention utilizes a 3-dimensional framework of risk, return, and how appropriate the assets are to an investor (suitability). The second utility function 120 provides the additional framework these sliders aim to elicit some of the suitability concerns, which can then be combined to offer different portfolios at different risk levels.

Choosing the appropriate level of risk is the work of the financial planner. Basically, each candidate is offered portfolios at different risk levels (low, medium, and high) and the candidate chooses the one for the level of risk one is willing to take. The user can also select one in the middle of these (for example, low-medium risk or low low-medium risk, and so on. Custom levels can be generated for advanced users between these). The sliders 111, 112 and 113 allow the financial planner to still do his duties of managing risk and understanding a client's financial goals but streamlines the day-to-day noise and activities of managing and understanding individual investments for him or her in a cost effective and data-driven way. As such, the assets are passed through the utility function algorithm to assign each asset a utility score. The utility function is a mathematical algorithm that assigns a real number to each asset based upon the correlation with the certain parameters. The assets are ranked or measured based on the preferences indicated by the sliders 111, 112 and 113, the higher the utility number, the closer the asset ranks to the preferences of the user. The utility function 120 of the present invention uses at least 3 levels of criteria. The sliders 111, 112 and 113 set the parameters. The parameters are entered into an algorithm which establishes the criteria. The utility function 120 operates the algorithm 130 to assign each asset from a sector 221, a particular score 2211a-2211d. A utility function is different from the machine learning component. The utility function simply sets the rules for how you make a decision in computer language, the program says, “I prefer A to B and B to C, so if given the choice between A and B, the program would choose A and given the choice between B and C, the program would choose B, and so on.”

The utility function used in the present invention is an estimated utility function. In other words, the system attempts to guess what a user's function is and using this estimated function in place of the real one because the real function is unknown. This is where machine learning and artificial intelligence is applied; it uses these tools to estimate the utility function. Machine Learning essentially provides a scoring process for the inputs that helps determine how close the application is to an accurate utility measurement. The application takes the slider inputs, pass it through a machine learning algorithm, and gain some measure of accuracy of how well the application is measuring utility functions. The application can then iterate and continue to improvement development of the utility function estimation process.

The application improves the utility function by using data generated by users in real-time to see how often financial planners deviate from the suggestions, why they deviate, and so on to determine trends and patterns about where the algorithms fail. This in a sense is a general approach for any specific utility function generation method, so the actual construction process could use any method but be updated in real-time (re-weighed and so on) based on machine learning.

Once the rules for the utility function are established, the sub-cluster assets 2211, 2212, 2213 and 2214 of sector 2211 are passed through the utility function 120. When the sub-cluster assets in sector 2211 are passed through the utility function 120, the score of each asset 2211 is compared to the score generated by the algorithm creating a utility score as part of the utility function 120. The sub-class assets in sector 2211 are classified in storage unit 140 based upon the utility score from the utility function. The individual stocks, 2211a, 2211b, 2211c and 2211d in sub-class assets 2211 with a higher utility score are cataloged in the storage unit 140. For example, stock 2211d in sector 2211 received a utility score of 1, which means it is not a good match. Whereas stock 4 (2211a) in sector 2211 received a utility score of 18 making it a better match. Stock 3 (2211b) and stock 4 (2211c) received neutral utility scores of 7 and 6, respectively.

Once the sub-cluster assets 2211 are passed through the utility function 120 and cataloged in the storage unit 140, the next step involved creating a final portfolio selector 150. The final portfolio is created based on the manner in which the sub-cluster assets 2211a-d are cataloged in the storage unit 140. For example, if the rule 151 of the final portfolio selector 150 is “long only,” the algorithm will select the highest scoring candidate stocks 2211a-d from the storage unit 140 to include in a final portfolio 160. In FIG. 3, the highest scoring stock is stock 4 (2211a). There could be more than one stock selected if there is more than one stock that has a utility score higher than the selected criteria. Alternatively, the rule 152 could state “long-short” the final portfolio selector 150 will choose the highest scoring candidate, short lowest scoring candidates. The final portfolio selector 150 routine will select the stock (2211a) to include in the final portfolio 161 for a long play while selecting stock 1 (2211d) as a short play. Finally, the selected stocks 2211a or 2211d may pass through a filter 170, 171 to iteratively add or drop stocks to optimize the global risk and return. The flagged stocks of “high scoring” and “low scoring” are candidates for a long-short portfolio.

All these stocks individually may meet the selected criteria, but together the assets may perform poorly. For example, consider Apple and companies that make parts for Apple. Apple and its suppliers have similar growth prospects and often would appeal to the same kind of investors. An analysis of each company individually, your portfolio as a growth investor might include Apple, its parts manufacturer, and a logistics company providing services to Apple.

The problem is that together, these companies mean the users are taking a risky position that is heavily exposed to Apple. Each of these pieces individually is acceptable, but together they are inappropriate. In order to hedge the Apple position, the asset manager may replace Apple's long position with a Microsoft long position in the portfolio.

The result of this process is that Apple might be a better fit of what we want in an individual stock, but it unbalances the portfolio.

From the selected stocks 2211a or 2211b, traditional methods such as optimization under the Sharpe ratio can be used to determine a final portfolio. This is because the assets may be individually suitable, but globally not optimal for a given investor. In the present innovation, the final search process can be customized and restricted to require certain floors or minimums on certain criteria or restrict certain criteria to certain ranges for specialized and targeted investment funds. As a further development in the product an optional one-click portfolio creation process is also provided for default generic portfolios.

This new approach combines daily exchange data with data stored and filed with the securities and exchange commission, typically on a quarterly basis. Because of this data disparity this represents two different flows of data with different levels of intensities. As such, the development of tools in a package to meaningfully use both of these streams of data in a way to reach conclusions that accounts for this disparity represents a new and innovative way of characterizing information.

The resulting developments may combine years of insights from diverse fields such as operations research, artificial intelligence development, machine learning, statistics, mathematics, quantitative finance, and equity analysis. Furthermore, these varied and diverse approaches are brought together to develop a set of features that represent a new way of understanding and managing risk that is only possible with the development of new cloud-based computing methods. The present invention represents a significant and non-trivial deviation from the traditional ways of managing and understanding risk. The underlying weights and specific analytical form derived from the process are numerous and can be selected by the creator.

Computations on matrices are different than computations on regular numbers. For example, they have different rules on multiplication. Because of this, we need to perform different techniques to handle them. GPU architecture is better built to handle these kinds of computations because it is purpose-built to perform computations similar to this. CPUs are not built specifically to perform these kinds of computations but are built to necessitate performing generic tasks that are often done by computers. For example, moving and copying files, deleting files, and accessing a web page. This is different from inverting a matrix or running long matrix-based computation chains.

Because the data is stored over time and because of the nature of some of the algorithms that are run (such as Markov Chain Monte Carlo), they end up performing matrix-based computations. While CPUs can perform them, they are not purpose built to do it and experience an efficiency loss. The method of the preferred embodiment refers to a GPU, however, it is understood that other processors, such as a CPU, may be used to replicate the results set forth here.

The sub-clusters 2211a-d from the initial process 140 are connected to the estimated utility function, which is elicited via the use of sliders, tick boxes and ranges of the user form 110. These utility functions 120 score each asset 21 and make a determination as to whether or not it should be considered as a candidate for the user. The highest scoring assets 2211a are added to a possible portfolio, which is then optimized. Options such as equal weights or weights heavier towards more suitable assets are possible, as well as options regarding maximum or minimum number of companies, companies to exclude, and sectors to exclude. Once this is done, the assets are passed on to ARIMA and GARCH functions to estimate return and volatility over time, and an iterative search proceeds. In this process, the asset that after re-weighting has the biggest improvement on the risk-return-suitability (based on the utility function) profile is re-weighted and this continues until no improvements can be made without negatively impacting risk, return, or suitability.

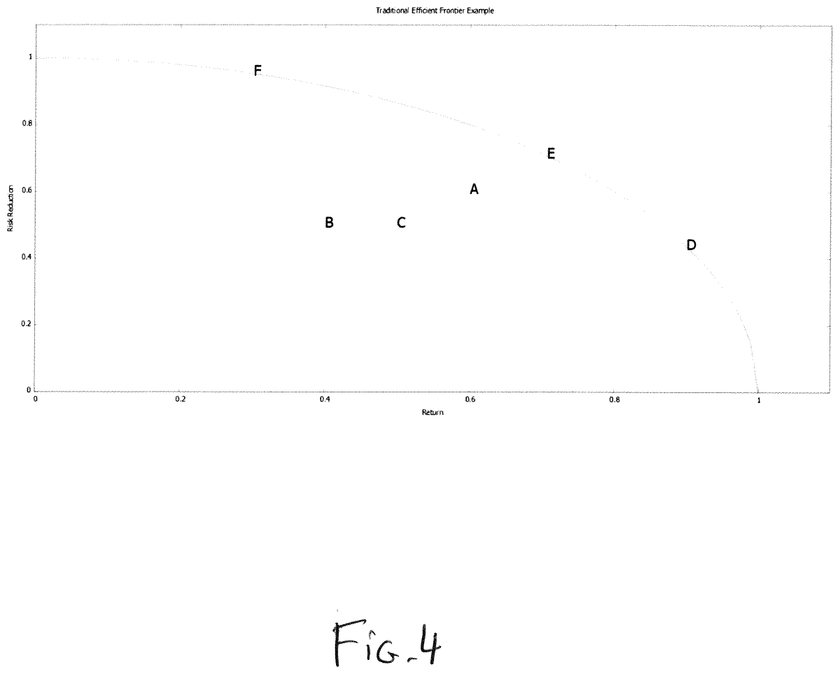

The diagram of FIG. 4 shows the traditional risk-return framework. Asset managers choose a portfolio that has the lowest risk for a given level of return in the traditional finance framework. In this case, the portfolio manager would choose either portfolio D, E, or F, depending on how much risk the client is willing to take.

This approach does not always make sense with current financial markets. The Securities and Exchange Commission prohibits investors from investing in hedge funds and speculative investments because while they may seem appropriate on a global scale, many investors do not understand the intricacies of these highly complex financial instruments. In other words, they are not suitable investments. Regulatory agencies in the United States are using an additional set of criteria to investigate financial decisions related to suitability, which is not being made explicit in the traditional representation of risk. This leads to the new representation used in the proposed innovative package of tools that extends the traditional risk-return framework to a risk-return-suitability method.

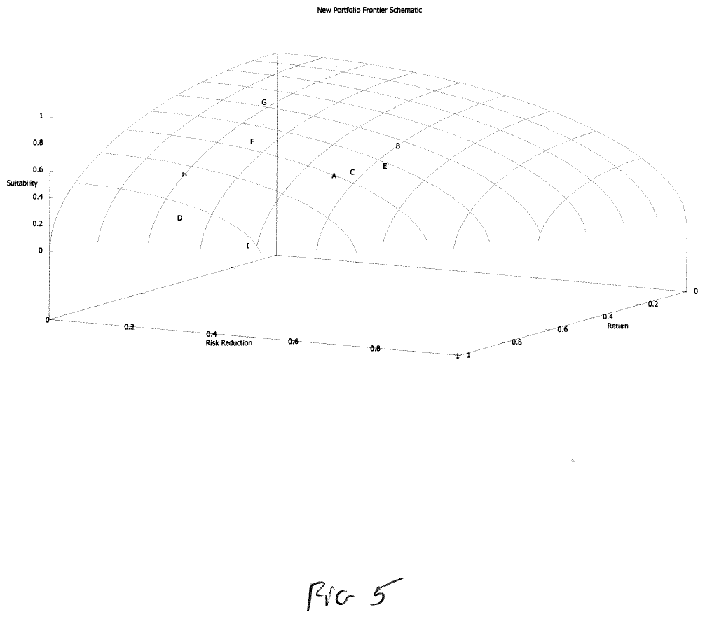

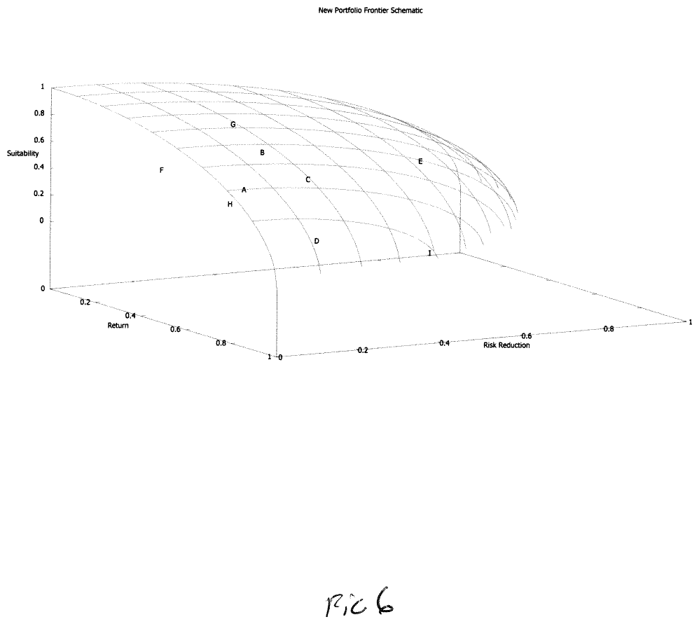

FIGS. 5 and 6 show the new risk-return-suitability framework used in the proposed patent. FIGS. 5 and 6 add a third criteria to the typical comparison of risk versus return in FIG. 4. The invention of the present invention adds the dimension of suitability 201 for the client, in addition to measuring return 202 and risk reduction 203. As shown in FIGS. 5 and 6, the assets are evaluated to see how appropriate they are for a given investor. For example, an employee of a technology company may have a great deal of exposure to the technology industry, and as such investing heavily in technology stocks would be inappropriate. Because of this, portfolios containing a great deal of technology companies in them would score poorly on the added suitability domain. Here, a portfolio manager would choose either portfolio E, G, or I. The proposed innovation uses artificial intelligence and machine learning to achieve the multi-dimensional process through the delivery mechanisms proposed and trade secret computational analytic programs.

Choosing the appropriate level of risk is the work of the financial planner who works with the user. Basically, the present invention offers different candidate portfolios at different risk levels (low, medium, and high) and he chooses the one for the level of risk one is willing to take. The user can also select one in the middle of these (for example, low-medium risk or low low-medium risk, and so on. Custom levels can be generated for advanced users between these). This allows the financial planner to still do his duties of managing risk and understanding a client's financial goals but streamlines the day-to-day noise and activities of managing and understanding individual investments for him or her in a cost effective and data-driven way.

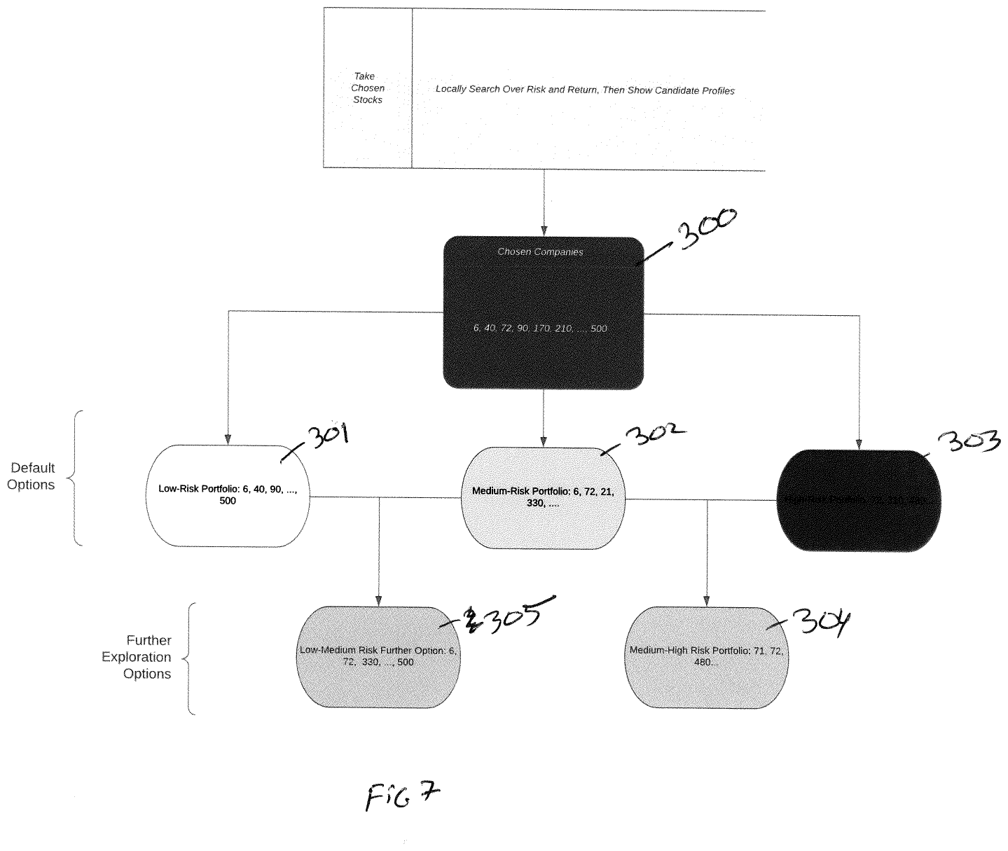

FIG. 7 shows the final mix of possible portfolios that consider the different possible target portfolios 300. The financial planner has three default options to choose for the portfolio: a low risk option 301, a medium risk option 302 and a high-risk option 303. The financial planner can adjust this to see some additional possible options. For example, the financial planner may want a portfolio that is between the medium and high-risk portfolio 305, so additional portfolios in this range can be generated. This allows the financial planner to adjust selections in real-time.

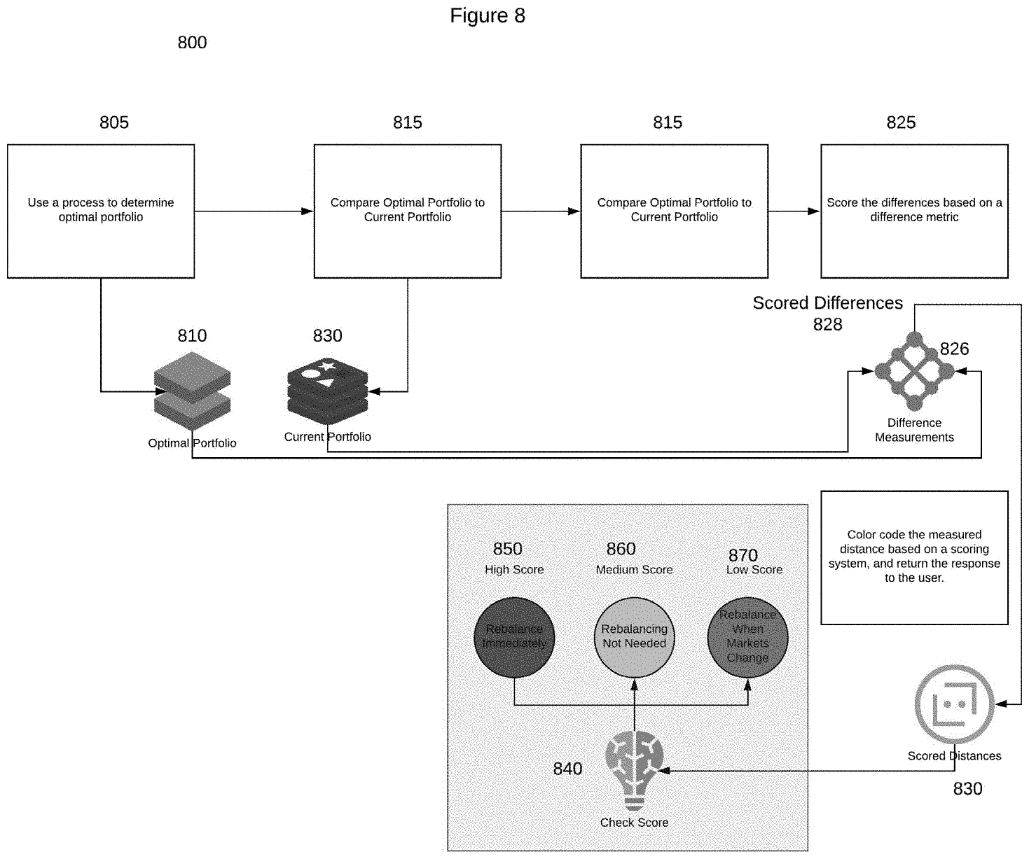

The next step in maintaining a portfolio after a current portfolio is created to rebalance the portfolio. The above-referenced process generates a current portfolio of assets. After time, the above reference process may be applied to a portfolio of assets to generate what may be called an optimal portfolio. As depicted in FIG. 8, the application 800 utilizes the above operation utilizing artificial intelligence and machine learning in a clustering process to develop a utility model 805 that generates an optimal portfolio 810. A current portfolio 820 contains assets created using a utility model described above with respect to FIGS. 1-3. The optimal portfolio 810 is compared to the current portfolio 820 in a comparison process 815. The scoring process 825 scores the differences between the current portfolio 820 and the optimal portfolio 810 by applying a difference metric procedure 826. The difference metric procedure 826 between the optimal portfolio 810 and the current portfolio 820 result in a scored differences 828. The scored differences 828 are then processed in a second differences application 830 that operates to check the score 840 and determines, based on the checked score 840, whether: (1) an immediate rebalancing is required 850, (2) no rebalancing is required 860 or (3) TO postpone a rebalancing until the market changes 870. A response to the user may be color coded based on the measured distance 826 scoring system 830 such that the returned response may indicate a red color for a score requiring immediate rebalance 850, a green color for a score requiring no immediate action 860 and a green color for a score requiring a rebalance when the market changes 870.

A goal of the rebalancing procedure focuses on slowly having the current portfolio 820 mimic the optimal portfolio 815 by changing the assets over time for the assets identified in the target portfolio. For the given portfolio, each user criterion will be evaluated in terms of importance to evaluate which assets are the least appropriate in the given mix. The algorithm will also determine the assets that are most important to be added to the current portfolio 820. For example, the current portfolio 820 may be overweight technology-based companies and underweight energy based companies but may also have real estate companies which are a poor match for the client. This approach would evaluate which of these positions needs to be adjusted the most at the highest priority by a distance metric-based algorithm combined with a utility function to determine which changes should occur optimally at what stages. The result is a suggested rebalancing order 850.

This technique is a new way of implementing asset rebalancing. The approach works in real-time to reflect quickly changing market conditions. It also allows for a gradual approach that takes advantage of these changing market conditions to allow clients to rebalance as appropriate. It uses artificial intelligence dynamically to aid in decision making while empowering financial professionals to improve their client relationships by allowing them to make better decisions about rebalancing.

The algorithm 830 and 840 outputs a level system that informs the user based on the difference in structure and utility what the difference is between the ideal portfolio 850 and actual portfolio 870 using the following signals:

Red—Portfolio is far off from ideal and is severely in need of rebalancing. Suggested to begin rebalancing immediately 850.

Yellow—Portfolio could use some rebalancing but it is not urgent. Rebalancing is suggested gradually over time and in favorable market conditions 860.

Green—Portfolio is not in need of rebalancing. The program would still suggest rebalances as market conditions allow for optimal decisions 870.

Alternatively, the algorithm 830 and 840 may list suggested rebalances for the portfolio with ratings as to how important each is to the portfolio on a continuous scale from 0 to 5, with 5 being the most urgent. For example, the checked score may be indicated as follows (not shown):

5—Immediate structure change suggested. Highly unsuitable or inappropriate asset in portfolio that should be removed urgently.

4—Urgent change recommended. Unsuitable or inappropriate asset in portfolio that should be removed.

3—Moderate rebalancing suggested—Change is recommended when convenient and market conditions are favorable.

2—Possible Rebalance—This change is suggested to improve the portfolio structure if the client has allocation concerns.

1—Low Priority Rebalance—These rebalance suggestions should only occur after all other options are pursued. The exchange fees for changes at this level may outweigh the gains in structure.

0—Very Low Priority Suggestions—Rebalance suggestions with marginal gains.

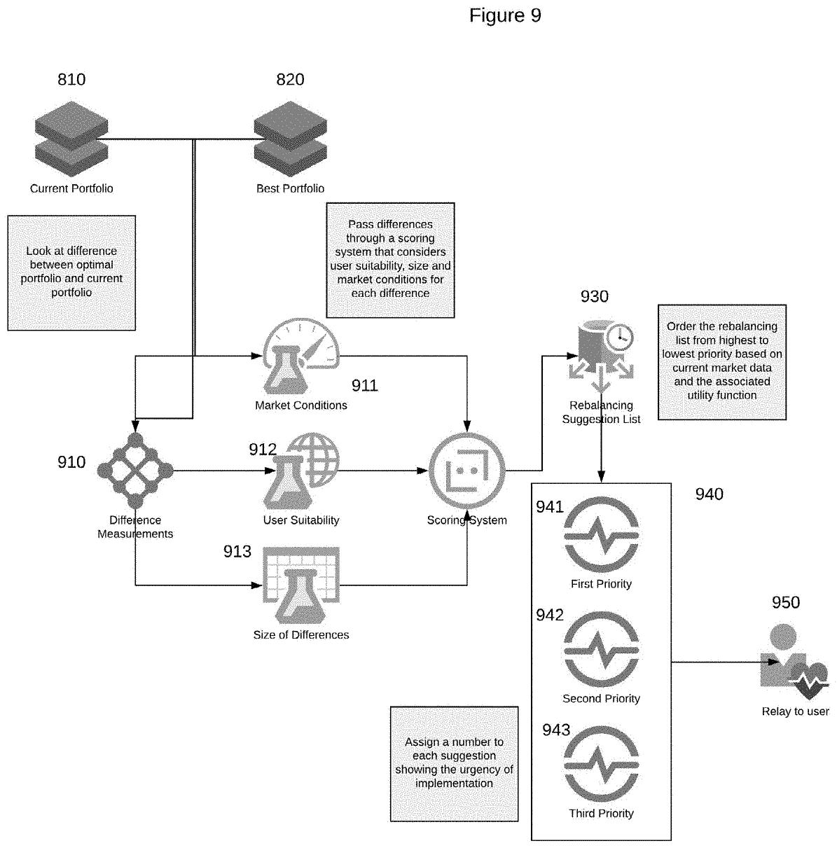

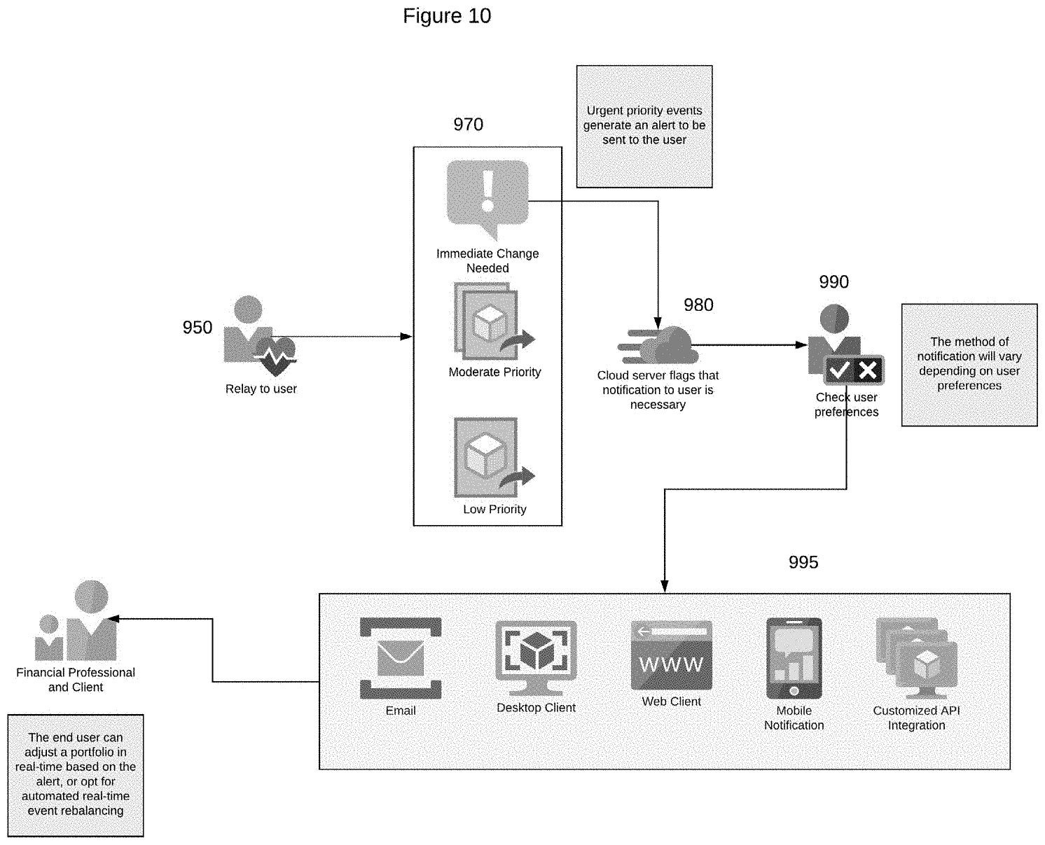

As shown in FIGS. 9 and 10, the process may implement a dynamic alert system that sends an alert to an advisor in real-time. An automated rebalance option is available that permits the advisor to allow an automatic rebalancing of a portfolio when suggested by the algorithm. The automated system begins with a current portfolio 820 of assets. The system uses the process of FIGS. 2 and 3 to generate an optimal portfolio 810 of proposed optimal assets. The optimal portfolio 810 is compared to the current portfolio 820 in an difference requirement algorithm 910 that analyzes differences between the optimal portfolio 810 and the current portfolio 820. The difference measurement algorithm 910 may take into a count and consider such factors as market conditions 911, user suitably 912 and size of the differences 913 with the outcome of the analysis resulting in a score in scoring system 920. The scoring system 920 will create a rebalancing suggestion list 930 that generates a list of order from the rebalancing suggestion listed from the highest priority based on a utility function associated with market data. Each of the results of the utility function assigns a priority weight 941, 942 and 943 to each suggestion showing the relative priority 940 for each priority 941, 942 and 943 which is conveyed to a user 950. If the priority events 941, 942 and 943 that are classified by the utility function as urgent, the system will generate an alert to send to the user 950.

The user 950 has a plurality of options 970 based on the priority 940 of the suggestions. A cloud server 980 may flag any notification that has been classified as urgent. The user 950 will provide a preference for how he/she prefers to be notified 980. The system checks the preferences selected by the user 990 and alert 995 the user of an urgent action by one of any numerous methods including, but not limited to, email, desktop computer, client website, other website, mobile phone notification or customized API integration. The user 950 may adjust a portfolio in real-time based upon the alert.

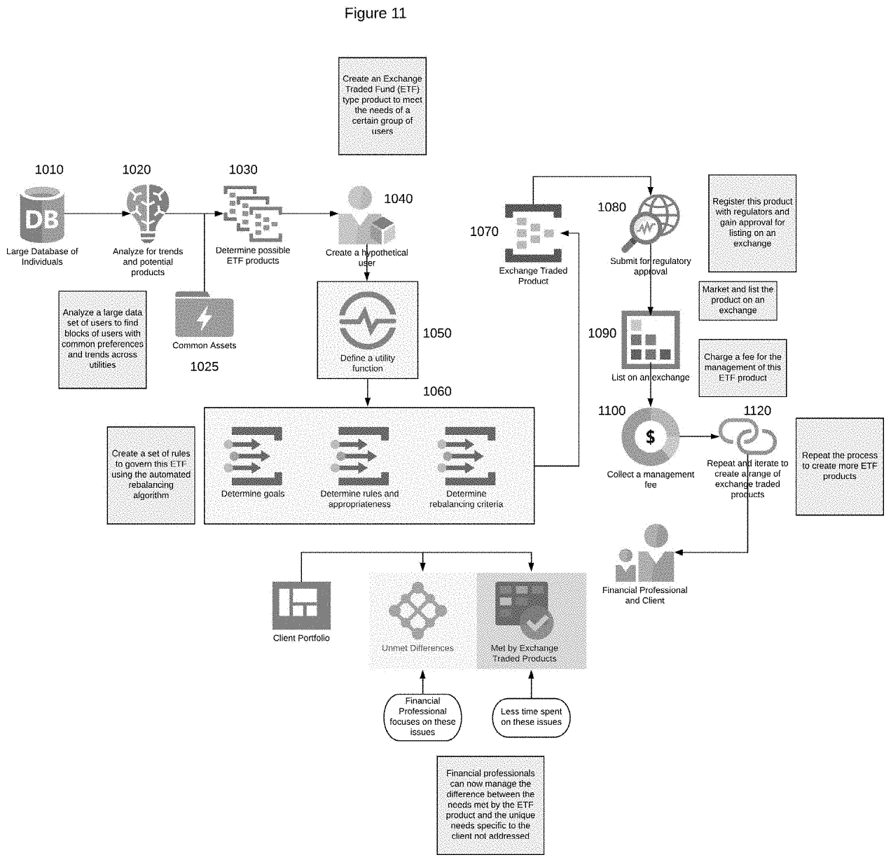

FIG. 11 depicts an exchange traded fund application. There is a technology for certain groups of clients or users of the system of the present invention to exhibit similar preferences or selected criteria for the portfolios. The system utilizes big data analytics to determine if a certain group of individuals may be viable to create an Exchange Traded Fund. The system manager utility functions to make the determination.

The process 1000 of creating an Exchange Traded Fund (ETF) combining individual portfolios to meet the criteria of a group of investors starts with a database of individual portfolios 1010. The system analyzes 1020 the assets in the individual portfolios to determine trends or potential common preferences. In other words, an analysis is run on the database to discovery individual portfolios to determine blocks of individual portfolios where the users have common preferences or criteria 1025 across a sector.

This analysis is conducted using big data analytics and machine learning. Machine learning is used to determine candidate criteria and factors to investigate by running through a large database of potential factors. After scaling down to a more manageable number of factors big data analytics is used to analyze structural trends in the data. As an example, the machine learning algorithm could determine a certain number of investors prefer oil companies that are profitable at a certain price range, and the big data analytics process could determine which oil companies may be suitable candidates to place together to reach diversification. Finally, optimization is done to select the optimal candidates and create an ETF style product. This analysis is data-driven and updates to meet new market trends, and as such is dynamic and reactive rather than a static mimic of an index.

The next step in the process involves determining 1030 whether a possible ETF product could be created from the portfolios having common preferences and criteria 1025. The system creates an optimal hypothetical user 1040 based on the portfolios having common preferences and criteria 1025. A utility function 1050 is defined by the system based upon a set of rules 1060. The utility function 1050 creates a set of rules to govern the ETF using automated rebalancing algorithms that: (1) determine goals, (2) determine the necessary rules and appropriateness and determining the rebalancing criteria.

As discussed previously, machine learning, big data analytics and optimization theory are used to determine initial allocation this process simply codifies these techniques and turns them into a set of rules-based orders. In other words, the optimizer is then repurposed to establish how often this rules-based portfolio should be shifted and restructured. If a certain company is no longer a good fit, the system allows for the algorithm to slowly over time reduce holdings in the company while slowly increasing holdings in more appropriate assets. For example, an oil producer that is no longer viable in a certain price range would be slowly removed from the portfolio holdings. The more inappropriate the asset is the quicker it will be removed. Further, the more liquid the asset is the quicker it will be removed. This process as such allows for a systematic approach for managing the ETF style product in an orderly manner. Once the utility function 1050 is established, the Exchange Traded Fund 1070 is created based on the utility function 1050 and the necessary assets and portfolios are added to the product. The ETF has portfolios and assets that are selected from the database based on the utility function 1050.

The ETF 1070 is registered with the necessary regulatory agency 1080 to gain approval for listing on an exchange. Once approved, the ETF is listed 1090 on an exchange. The company that manages and provides the ETF 1080 may charge a management for 1100 for management of the ETF.

More than one ETF 1100 may be created by the system 1120. Financial professionals may manage the criteria of individual users through the ETF products based on unique criteria of a group of users. The automated rebalancing option allows the financial professional to click a button and automatically have the algorithm create trade requests. This would allow the portfolio rebalancing to engage in an “auto-pilot” rebalancing mode that works as follows:
1. Identify a group of individuals with similar investment goals and characteristics using big data analytics.
2. Structure an ETF style product that meets a utility function derived from this group based on the first patent application.
3. Formalize the rules for this ETF product for a given set of customers; determine the appropriate utility function; determine automated rebalancing rules; use the automated rebalancing rules to structure the fund over time, balancing exchange fees with user suitability, using the given automated rebalancing algorithms; and deduct a management fee on a scheduled basis.
4. Offer this ETF product through a filing made with the Securities in Exchange Commission, or through a similar process in other countries besides the United States of America.
5. Charge a fee to customers for this ETF product.
6. Allow users to purchase the ETF product.
7. Synchronize the ETF product with other offerings in a smart and intelligent system for securities recommendations for clients.

The present inventions have been described with reference to specific exemplary embodiments. It will be evident that various modifications and changes may be made to the embodiments disclosed in this application without departing from the broadest spirit and scope of the present invention as set forth in the disclosure herein. Accordingly, the specification and drawings are to be regarded as illustrative of the invention rather than restricting the invention to the specific embodiments disclosed.

The embodiments of the invention described herein and the contents of the preferred embodiments are not to be taken as limiting the scope of the invention to the details provided, since modifications and variations may be made to the preferred embodiments without departing from the spirit and scope of the embodiments of the invention.

What is claimed is:

1. A computer implemented data-processing system to rebalance an existing portfolio of assets comprising:
a data storage apparatus;
a processor and a program logic stored in a memory and the program logic executable by the processor, the program logic including:
portfolio management logic coupled to the processor and data storage apparatus, the portfolio management logic including a portfolio processing logic configured to analyze a plurality of current portfolio assets stored in the data storage apparatus configured to:
define a group of current portfolio assets to be analyzed and selecting a preference criteria from the data storage apparatus;
compile a first utility function based upon the preference criteria;
pass the defined group of current portfolio assets through a defined group utility function to assign a utility relevancy score to each of the assets in the group of current portfolio assets;
rank the assets in the group of current portfolio assets based upon the utility relevancy score assigned to each of the assets and cultivate a final current relevancy score;
the portfolio management logic further including an optimal processing logic configured to generate an optimal portfolio of assets configured to:
define a group of optimal portfolio assets based on an optimal criteria;
compile a second utility function based on the optimal criteria;
pass the defined group of optimal portfolio assets through the optimal portfolio to generate an optimal portfolio utility score for each of the assets in the optimal portfolio;
rank the assets in the group of optimal portfolio assets based upon the optimal relevancy score assigned to each of the assets;
compare the utility relevancy score of the ranked assets to the utility score for an optimal portfolio;
create an optimal portfolio of the ranked assets which match the utility score for the optimal portfolio;
portfolio comparison logic coupled to the portfolio management logic and data storage apparatus configured to:
score the assets in the optimal portfolio to generate an optimal portfolio relevancy score for each asset;
determine the differences between the optimal portfolio relevancy score for each asset and the current portfolio relevancy score for the assets;
pass the differences through a final scoring system which determines the priority of a rebalancing the current portfolio and providing an indication priority; and
indicating to a user the indication of priority of the rebalancing suggestion.

2. The computer implemented data-processing system to rebalance an existing portfolio of claim 1, further comprising a color indication system function established on the indication priority of the rebalancing a current portfolio.

3. The computer implemented data-processing system to rebalance an existing portfolio of claim 2, wherein a first color indication in the color indication functions to indicate that the current portfolio is in critical need of rebalancing.

4. The computer implemented data-processing system to rebalance an existing portfolio of claim 3, wherein a second color indication functions to indicate that the current portfolio is not in need of rebalancing.

5. The computer implemented data-processing system to rebalance an existing portfolio of claim 4, wherein a third color indication functions to indicate that the current portfolio should be rebalanced over a predetermined time period.

6. The computer implemented data-processing system to rebalance an existing portfolio of claim 1, further comprising a scale indication function based on the indication priority of the rebalancing.

7. The computer implemented data-processing system to rebalance an existing portfolio of claim 6, wherein the scale includes a first indication function indicating an immediate structural change to the current portfolio is suggested.

8. The computer implemented data-processing system to rebalance an existing portfolio of claim 7, wherein the scale includes a second indication function indicating no structural change to the current portfolio is suggested.

9. The computer implemented data-processing system to rebalance an existing portfolio of claim 1, wherein the defined group utility function based upon the preference criteria uses artificial intelligence.

10. The computer implemented data-processing system to rebalance an existing portfolio of claim 1, wherein the optimal portfolio utility function based upon the preference criteria uses machine learning.

11. The computer implemented data-processing system to rebalance an existing portfolio of claim 10, wherein the defined group utility function based upon the preference criteria uses artificial intelligence.

12. The computer implemented data-processing system to rebalance an existing portfolio of claim 1, further comprising a rebalance notification system alerting a user to the priority of rebalancing a current portfolio.

13. The computer implemented data-processing system to rebalance an existing portfolio of claim 12, further comprising a cloud server to flag notifications to the user.

14. The computer implemented data-processing system to rebalance an existing portfolio of claim 1, wherein the defined group utility function applies current stock market conditions.

15. The computer implemented data-processing system to rebalance an existing portfolio of claim 14, wherein the defined group utility function applies user suitability.

16. A computer implemented data-processing system to create and Exchange Traded Fund (ETF) comprising:
a database storage device;
a processor and program logic stored in memory and executable by a processor, the program logic including storage logic coupled to the database storage device for storing user criteria in the database storage devices;
analysis logic coupled to the data storage apparatus, the analysis logic configured to correlate user criteria that are common among users and creating a common criteria blocks;
utility function logic coupled to the data storage apparatus, the utility function logic configured to:
determine possible ETF products based upon the common criteria blocks;
creating a theoretical user;
define a utility function having a set of rules to govern the creation and function of the possible ETF;
create an ETF exchange product based upon the utility function set of rules for creating the ETF with suggested assets;
populate the ETF exchange product with the suggested assets;
manage the ETF exchange product based upon the set of rules defining how to govern the function of the ETF exchange product.

17. The computer implemented data-processing system to create an ETF of claim 1, further comprising the step of listing the ETF on an exchange.

18. The computer implemented data-processing system to create an ETF of claim 17, further comprising the step of collecting a management fee for the ETF.

19. The computer implemented data-processing system to create an ETF of claim 16, wherein the set of rules for the utility function provides for rules for rebalancing the ETF.

20. The computer implemented data-processing system to create an ETF of claim 16, wherein the set of rules for the utility function provide for rules for goals of an asset in the possible ETF.
